(19) United States
(12) Patent Application Publication
(10) Pub. No.: US 2020/0226528 A1
(43) Pub. Date: Jul. 16, 2020

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventors: Yuki TAGAWA, Kanagawa (JP); Takayuki YAMAMOTO, Kanagawa (JP)

(73) Assignee: FUJI XEROX CO., LTD., Tokyo (JP)

(21) Appl. No.: 16/515,013

(22) Filed: Jul. 17, 2019

(30) Foreign Application Priority Data
Jan. 11, 2019 (JP) 2019-003508

(51) Int. Cl. G06Q 10/06; G06F 3/0484

(52) U.S. Cl. CPC G06Q 10/06398; G06F 3/04847

(57) ABSTRACT

An information processing apparatus includes a reception section that receives one or a plurality of segments input by a user, a first specifying section that specifies each concept corresponding to at least one segment received by the reception section among concepts present in concept structure information in which concepts having a relationship are related to each other in a hierarchical structure, a second specifying section that specifies a position of each concept specified by the first specifying section in a hierarchy of the concept structure information, and a decision section that decides a professionalism degree of the user in a field which is specified based on the concept structure information including the concept corresponding to the segment received by the reception section from the position of each concept specified by the second specifying section.

### CROSS-REFERENCE TO RELATED APPLICATIONS

This application is based on and claims priority under 35 USC 119 from Japanese Patent Application No. 2019-003508 filed Jan. 11, 2019.

### BACKGROUND

### (i) Technical Field

The present invention relates to an information processing apparatus and a non-transitory computer readable medium storing a program.

### (ii) Related Art

Users have various knowledge levels in a certain field. Thus, for example, it is preferable to provide a user performing search with a content matching the knowledge level of the user as a search result. The knowledge level of the user is considered as representing a professionalism level, that is, a professionalism degree, in the field. In the related art, a technology for causing the user to self-report (input) a level (professionalism degree) in the field of the search in the execution of the search and providing a content of a level corresponding to the input professionalism degree is suggested (for example, JP5292322B).

### SUMMARY

In a case where the user inputs information, recognizing the professionalism degree of the user in the field of the input information requires the user to input the professionalism degree of the user in the field. Thus, the user may not be comfortable.

Aspects of non-limiting embodiments of the present disclosure relate to an information processing apparatus and a non-transitory computer readable medium storing a program capable of automatically recognizing a professionalism degree of a user at the time of recognizing the professionalism degree of the user in the field of input information in a case where the user inputs information.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus includes a reception section that receives one or a plurality of segments input by a user, a first specifying section that specifies each concept corresponding to at least one segment received by the reception section among concepts present in concept structure information in which concepts having a relationship are related to each other in a hierarchical structure, a second specifying section that specifies a position of each concept specified by the first specifying section in a hierarchy of the concept structure information, and a decision section that decides a professionalism degree of the user in a field which is specified based on the concept structure information including the concept corresponding to the segment received by the reception section from the position of each concept specified by the second specifying section.

### BRIEF DESCRIPTION OF THE DRAWINGS

Exemplary embodiment(s) of the present invention will be described in detail based on the following figures, wherein:

FIG. 1 is a block configuration diagram of an information processing apparatus in Exemplary Embodiment 1;

FIG. 2 is a diagram schematically illustrating a relationship between concepts included in concept structure information that is set and registered in a concept structure information storage unit in Exemplary Embodiment 1;

FIG. 3 is a flowchart illustrating a search process in Exemplary Embodiment 1;

FIG. 4 is a diagram schematically illustrating a relationship between concepts included in another concept structure information in Exemplary Embodiment 1;

FIG. 5 is a block configuration diagram of an information processing apparatus in Exemplary Embodiment 3; and

FIG. 6 is a diagram schematically illustrating a difficulty dictionary included in a difficulty dictionary storage unit in Exemplary Embodiment 3.

### DETAILED DESCRIPTION

Hereinafter, exemplary embodiments of the present invention will be described based on the drawings.

### Exemplary Embodiment 1

An information processing apparatus according to the present exemplary embodiment may be implemented by a general-purpose hardware configuration such as a personal computer (PC) that is already present. That is, the information processing apparatus is configured by connecting a CPU, a ROM, a RAM, a storage section such as a hard disk drive (HDD), and a user interface to an internal bus. The user interface is composed of an input section such as a mouse and a keyboard and a display section such as a display. The user interface may be configured to double as the input section and the display section like a touch panel.

In addition, the storage section is not necessarily limited to a constituent incorporated in the information processing apparatus and may be disposed in another apparatus connected to a network such as a local area network (LAN) and the Internet. In this case, a network interface matching the connecting network is connected to the internal bus.

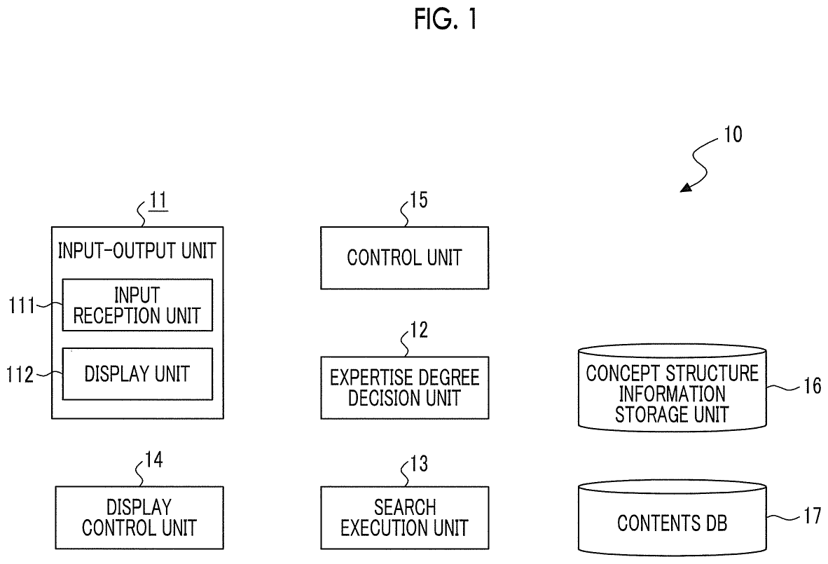

FIG. 1 is a block configuration diagram illustrating the information processing apparatus according to one exemplary embodiment of the present invention. An information processing apparatus 10 in the present exemplary embodiment includes an input-output unit 11, a professionalism degree decision unit 12, a search execution unit 13, a display control unit 14, a control unit 15, a concept structure information storage unit 16, and a contents database (DB) 17. Constituents not used in the description of the present exemplary embodiment are omitted from FIG. 1.

The input-output unit 11 inputs and outputs data through the user interface. An input reception unit 111 included in the input-output unit 11 receives data, specifically, a search condition, input from a user. The “search condition” is a condition that is input and designated by the user in the case of causing the search execution unit 13 to execute search. Basically, a query in a case where the search execution unit 13 executes search is designated as the search condition. Additional settings such as a search scope and the type of information (for example, an image) may also be available. However, additional settings are not particularly necessary in the present exemplary embodiment. Thus, the search condition is limited to the query for convenience of description. The user designates one or plural search keywords for the query. The keyword is not limited to a word (so-called single word) and may be designated as a phrase. Alternatively, a natural text (that is, a search text) including one or plural segments may be designated.

The display unit 112 performs control for displaying an execution result (hereinafter, referred to as a “search result”) of a search process of the search execution unit 13 on a display screen or the like under control of the display control unit 14. The present exemplary embodiment is described on assumption that the display connected to the information processing apparatus 10 is the display location and the mouse, the keyboard, and the like connected to the information processing apparatus 10 are the input section. In a case where the information processing apparatus 10 is used from an external apparatus, for example, a user terminal, through the Internet, the input-output unit 11 transmits and receives data through the network interface.

The professionalism degree decision unit 12 functions as a first specifying section that extracts segments by analyzing the query received by the input reception unit 111 and specifies a concept corresponding to at least one of the extracted segments based on concept structure information included in the concept structure information storage unit 16. A “search segment” refers to the specified concept and is a segment used in the execution of the search by the search execution unit 13. In addition, the professionalism degree decision unit 12 functions as a second specifying section that specifies a hierarchical position of each specified concept in the concept structure information. Furthermore, the professionalism degree decision unit 12 functions as a decision section that decides the professionalism degree of the user in a field of each concept specified from the specified position of each concept by referring to the concept structure information.

The “professionalism degree of the user” represents the knowledge and experience of the user. For example, the professionalism degree is decided for each field. Accordingly, the user has a different professionalism degree depending on the field. A segment (professional term) used by a professional in a certain field is considered as a segment used by a highly professional user and is not easily used by a general user (user not having special professional knowledge in the field). Thus, the professionalism degree is an indicator of a difficulty in the field. Accordingly, in a case where the segment input by the user is a highly professional term in the field, that is, a term having a relatively high difficulty, it may be determined that the professionalism degree of the user is relatively high. In a case where the segment input by the user is a general-purpose term in the field, that is, a term having a relatively low difficulty, it may be determined that the professionalism degree of the user is relatively low. That is, in the present exemplary embodiment, the difficulty of the segment input by the user is estimated to be the professionalism degree of the user. The professionalism degree of the user is automatically determined by analyzing the difficulty of the segment input by the user.

In addition, the “segment” means a word or a phrase. Simple words (single words) and phrases are registered in the concept structure information storage unit 16. Thus, the search execution unit 13 may execute the search based on the phrase. In the present exemplary embodiment, the representation “segment” is used considering such a case.

The search execution unit 13 executes the search process based on the search segment and the professionalism degree in the field specified by the professionalism degree decision unit 12. In the present exemplary embodiment, the search location of the search execution unit 13 is the contents database 17. The search execution unit 13 may obtain the field related to the search segment from the professionalism degree decision unit 12 considering a case where contents accumulated in the contents database 17 correspond to plural fields. The display control unit 14 performs control for displaying the search result of the search execution unit 13 on the display unit 112 under control of the control unit 15. The control unit 15 controls each of the constituents 11 to 14 to execute processes described below.

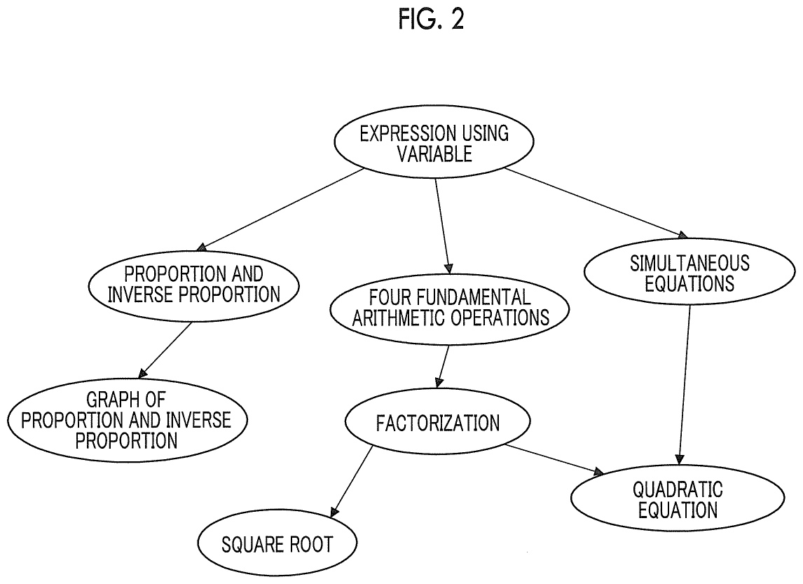

FIG. 2 is a diagram schematically illustrating a relationship between concepts included in the concept structure information that is set and registered in the concept structure information storage unit 16 in the present exemplary embodiment. The “concept structure information” is information in which plural concepts are structured by relating the concepts to each other in a semantic relationship. In the present exemplary embodiment, a semantic relationship between plural concept is represented as a hierarchical structure as illustrated in FIG. 2. In FIG. 2, “proportion and inverse proportion”, “four fundamental operations”, and the like are titles (correspond to the “segment”) representing concepts defined in the concept structure information (concepts have titles). Since titles vary depending on the concepts, the concept and the title can be regarded as having the same definition in the case of visualizing the structure of the concept structure information as illustrated in FIG. 2.

For example, it is assumed that a concept having a title “personal computer” is included in the concept structure information. Concepts having titles “PC” and “personal com” are not included. Since the segments “PC” and “personal com” are present, the user may designate the segment “PC” or “personal com” in the query. The segment “PC” or “personal com” is semantically associated with the concept having the title “personal computer” included in the concept structure information. The “segment” included in the “concept corresponding to the segment” corresponds to “PC” or “personal com” illustrated above. The “concept” included in the “concept corresponding to the segment” corresponds to “personal computer” illustrated above. That is, “PC”, “personal com”, and the concept corresponding to the segment “personal computer” are concepts having the title “personal computer”. Accordingly, the segment is associated with the concept included in the concept structure information based on the meaning of the segment.

Each concept is directly or indirectly linked by a semantic relationship between concepts. A hierarchical relationship formed by the linking forms a hierarchically vertical relationship between concepts. For example, a vertical relationship as illustrated by arrows in FIG. 2 is formed among “four fundamental operations”, “factorization”, and “square root”. Concepts not forming a hierarchy with other concepts may also be present in the concept structure information.

In the concept structure information, a concept at a superordinate position in the hierarchy is recognized as a general-purpose concept. A concept at a subordinate position in the hierarchy is recognized as a highly professional concept. In addition, the concept may be a concept corresponding to a collective term of concepts linked in the subordinate layer, for example, a superordinate concept representing a group (referred to as a “class”) of concepts positioned in the subordinate layer. The title representing the concept is generally represented as a single word in the segment. The title may be represented as a phrase and not a single word.

In addition, in the hierarchy, a concept may be positioned in a layer immediately below plural concepts. In other words, a concept having plural concepts immediately above the concept may be present and fall into plural layers. In FIG. 2, “factorization” and “simultaneous equations” are present as concepts immediately above “quadratic equation”, and “quadratic equation” falls into a layer formed by “expression using variable”, “four fundamental operations”, and “factorization” and a layer formed by “expression using variable” and “simultaneous equations”.

In addition, the concept structure information may have plural most superordinate concepts in the hierarchy. Concepts belonging to one field are defined by a hierarchical structure reaching to the subordinate layer from the most superordinate concept. That is, the number of fields defined by the concept structure information corresponds to the number of most superordinate concepts. The concepts present in the concept structure information may fall into plural layers formed from plural most superordinate concepts. Accordingly, concepts linked to plural most superordinate concepts are concepts belonging to plural fields. In FIG. 2, as described above, “quadratic equation” falls into plural layers and is linked to the common most superordinate concept “expression using variable”. However, “quadratic equation” may be linked to the most superordinate concept other than “expression using variable”. For example, in a case where “quadratic equation” is linked to a most superordinate concept “mathematics learned at high school”, “quadratic equation” belongs to plural fields. The relationship between concepts is not necessary a one-on-one correspondence, and a concept related to plural concepts is also present. Accordingly, plural paths to a certain concept may be present.

The contents database 17 is a storage section in which a large amount of information (contents) is accumulated. As described above, the field is defined by the concept structure information. A level that indicates professionalism (or the difficulty) at any of plural levels of a general-purpose level to a highly professional level in at least one field defined by the concept structure information is set in advance for each content. The search execution unit 13 may search for an external content through the Internet. In the present exemplary embodiment, the contents database 17 is the search location of the search execution unit 13.

In the information processing apparatus 10, each of the constituents 11 to 15 is implemented by a cooperative operation between a computer forming the information processing apparatus 10 and a program operated by a CPU mounted in the computer. In addition, each of the storage sections 16 and 17 is implemented by an HDD mounted in the information processing apparatus 10. Alternatively, a RAM or an external storage section may be used through a network.

In addition, the program used in the present exemplary embodiment may be provided by a communication section and may also be provided by storing the program in a computer readable recording medium such as a CD-ROM and a USB memory. The program provided from the communication section or the recording medium is installed on the computer. The CPU of the computer implements various processes by executing the program in order.

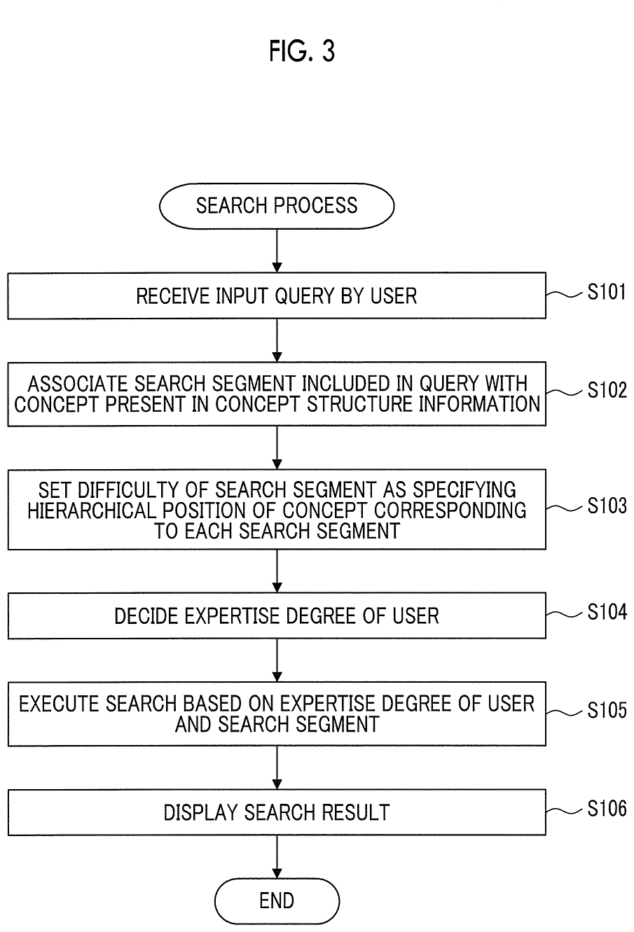

In the present exemplary embodiment, in a case where the query is input by the user, a search result matching the professionalism degree of the user in the field specified from the query is obtained. Particularly, in the present exemplary embodiment, the professionalism degree of the user in the field specified from the query may be automatically determined from the query input by the user. Hereinafter, the search process including the automatic determination of the professionalism degree of the user will be described using the flowchart illustrated in FIG. 3.

In a case where the user inputs and designates the query from a predetermined screen, the input reception unit 111 receives the input query (step S101). The user may not input the query as a text using the keyboard and the like. For example, the display control unit 14 may display segments as query candidates in a selectable manner on the screen and cause the user to select one or plural desired segments from the displayed segments. Accordingly, the concept input by the user includes the selection of the user. In addition, the user may input the query using other methods such as voice without inputting the query as a text. In a case where the query is input by voice, a function of analyzing and converting the voice into a text is necessary.

In a case where the input reception unit 111 receives the query input by the user, the professionalism degree decision unit 12 specifies a segment as the search segment by analyzing the query and specifies a concept corresponding to each specified segment by referring to the concept structure information (step S102). According to the above example, in a case where the user inputs “personal com” in the query, “personal com” corresponds to the concept having the title “personal computer”. As in the case of inputting “personal computer” in the query by the user, in a case where the segment included in the query is defined as the title of the concept in the concept structure information, in other words, in a case where the concept having the same title as the segment included in the query is defined in the concept structure information, the segment is easily associated with the concept. However, the segment (for example, “personal com”) included in the query does not necessarily match the title (for example, “personal computer”) of the concept present in the concept structure information. Therefore, the professionalism degree decision unit 12 specifies the concept corresponding to the segment included in the query from the concepts present in the concept structure information by referring to a dictionary (not illustrated) of synonyms and the like.

As described above, the concept structure information indicates the hierarchical relationship between concepts in each field. In the present exemplary embodiment, a concept at a superordinate position in the hierarchy in the concept structure information is recognized as a general-purpose concept, and a concept at a subordinate position in the hierarchy is recognized as a highly professional concept. That is, the professionalism degree of each concept belonging to a certain field can be represented by a depth from the most superordinate concept in the field.

In the case of specifying the search segment and the concept corresponding to the search segment, the professionalism degree decision unit 12 specifies the depth of the concept in the hierarchy indicated by the concept structure information as the position of the search segment. That is, the position of the search segment is indicated by the depth to the concept from the most superordinate concept of the field including the concept corresponding to the search segment. As described above, the concept structure information includes the concept (title of the concept) corresponding to the search segment. For convenience of description, the concept or the title of the concept corresponding to the search segment and included in the concept structure information will be simply referred to as the “search segment”. That is, the “depth of the search segment” described below means the depth to the concept from the most superordinate concept of the field including the concept corresponding to the search segment.

The professionalism degree decision unit 12 sets the difficulty of the search segment as the depth of the search segment (step S103). In FIG. 2 illustrating the hierarchical relationship of concepts in the field “equation using variable”, for example, it is assumed that the user designates “factorization”, “square root”, and “details” in the query. While both of “factorization” and “square root” belong to the field “expression using variable”, the depth of “factorization” from the most superordinate concept “expression using variable” is 2. In addition, the depth of “square root” from the most superordinate concept “expression using variable” is 3. A search segment having a large depth is a highly professional search segment. Thus, the difficulty of the search segment is high. In the present exemplary embodiment, the depth of the search segment is the indicator of the difficulty of the search segment. That is, as described above, in the concept structure information, the difficulty of “factorization” is 2, and the difficulty of “square root” is 3.

General segments such as “details” and “summary” that not are considered as indicating professionalism are concepts not belonging to any field and thus, may not be defined in the concept structure information. For such segments, a difficulty dictionary (not illustrated) is separately prepared in the present exemplary embodiment. For example, “details” is not a professional term but has a high difficulty. Thus, the difficulty of “details” is set to 3. The term “summary” has a low difficulty. Thus, the difficulty of “summary” is set to 1. The difficulty of the segment such as “details” not defined in the concept structure information is set in the above manner.

In a case where the difficulty of each search segment is obtained in the above manner, next, the professionalism degree decision unit 12 decides the professionalism degree of the user (step S104). In the present exemplary embodiment, the professionalism degree is calculated using a calculation expression professionalism degree=(total of difficulty of each search segment)/number of search segments. As described above, the difficulties of the search segments “factorization”, “square root”, and “details” are obtained as 2, 3, and 3, respectively. Accordingly, the professionalism degree may be calculated as (2+3+3)/3=2.67. Accordingly, the professionalism degree of the user is decided (step S104).

In addition, for example, it is assumed that the user designates “simultaneous equations” and “quadratic equation” in the query. While both of “simultaneous equations” and “quadratic equation” belong to the field “expression using variable”, the depth of “simultaneous equations” from the most superordinate concept “expression using variable” is 1. In the hierarchy, “quadratic equation” falls into two paths including a path consisting of “expression using variable”, “four fundamental operations”, and “factorization” and a path consisting of “expression using variable” and “simultaneous equations”. Thus, the depth of “quadratic equation” may be 2 or 3. Here, the depth will be described as 2. That is, the difficulties of “simultaneous equations” and “quadratic equation” are 1 and 2, respectively. In this case, the professionalism degree may be calculated as (1+2)/2=1.5.

In the present exemplary embodiment, as is perceived from the above calculation expression, it is decided that the professionalism degree of the user is higher as the position in the hierarchy of the search segment is deeper. In addition, the depth of the search segment is larger as the number of concepts present between the most superordinate concept of the concept structure information and the search segment is larger. In a case where the depth of the search segment is increased, the difficulty of the search segment is increased. Thus, the professionalism degree of the user is increased.

In the above description, the depth of “quadratic equation” is set to 2 and not 3. In the present exemplary embodiment, the depth of 2 is employed in accordance with the following rule.

In a case where a concept such as “quadratic equation” illustrated in FIG. 2 is related to plural concepts, that is, the immediately above concepts “simultaneous equations” and “factorization”, a path including the concepts (that is, “simultaneous equations” and “quadratic equation”) corresponding to the segments included in the query is specified between the most superordinate concept (“expression using variable”) of the concept structure information and the concept (that is, the search segment “quadratic equation”) corresponding to the segment related to the plural concepts. In the concept structure information illustrated in FIG. 2, all of the concepts (that is, “simultaneous equations” and “quadratic equation”) corresponding to the segments included in the query are included in a path (hereinafter, a “path A”) formed from “expression using variable”, “simultaneous equations”, and “quadratic equation” of two paths from the most superordinate concept to the search segment (“quadratic equation”). A path (hereinafter, a “path B”) formed from “expression using variable”, “four fundamental operations”, “factorization”, and “quadratic equation” does not include “simultaneous equations” in the concepts (that is, “simultaneous equations” and “quadratic equation”) corresponding to the segments included in the query. Thus, in the present exemplary embodiment, the path A that includes all of the concepts corresponding to the segments included in the query is specified from all paths (two paths). Accordingly, the depth of “quadratic equation” is set to 2.

For example, it is assumed that the user designates “proportion and inverse proportion” and “quadratic equation” in the query. In this case, “proportion and inverse proportion” does not belong to any of the paths A and B. In this case, the difficulty of “quadratic equation” may be set in accordance with a rule such that the minimum, the maximum, or the average of the depths 2 and 3 corresponding to all paths from the most superordinate concept to “quadratic equation” is employed.

In a case where the professionalism degree decision unit 12 decides the professionalism degree of the user in the above manner, the search execution unit 13 executes search based on the decided professionalism degree and the search segment included in the query (step S105). While the search location is the contents database 17, a professionalism level, in other words, the difficulty of information provided by the content, is set for each content accumulated in the contents database 17. Thus, the search execution unit 13 selects the search result to be provided to the user from search results obtained by executing the search based on the search segment by comparing the professionalism level of each content included in the search result with the professionalism degree of the user decided by the professionalism degree decision unit 12.

For example, it is assumed that the professionalism level of the content is set as an integer number. In a case where the professionalism degree of the user is 2.67, a content having a professionalism level of 3 is selected by rounding off the professionalism degree of the user. Alternatively, contents having professionalism levels of 2 and 3 before and after the professionalism degree of the user may be selected.

In a case where the search execution unit 13 obtains the search result matching the professionalism level of the user in the above manner, the display control unit 14 provides the search result to the user by displaying the search result on the display unit 112 (step S106).

As described thus far, according to the present exemplary embodiment, the professionalism degree of the user may be automatically determined based on the query input by the user, and the content matching the professionalism degree may be provided to the user. Accordingly, without inputting the professionalism degree of the user, the user may obtain the search result narrowed down to the content matching the professionalism level of the user in the field.

In a case where the user inputs the professionalism degree of the user, the input professionalism degree does not need to be used in the above description. However, after the input is received, the input may be referred to and reflected on the calculated professionalism degree of the user, or the professionalism degree of the user may be determined without referring to the input.

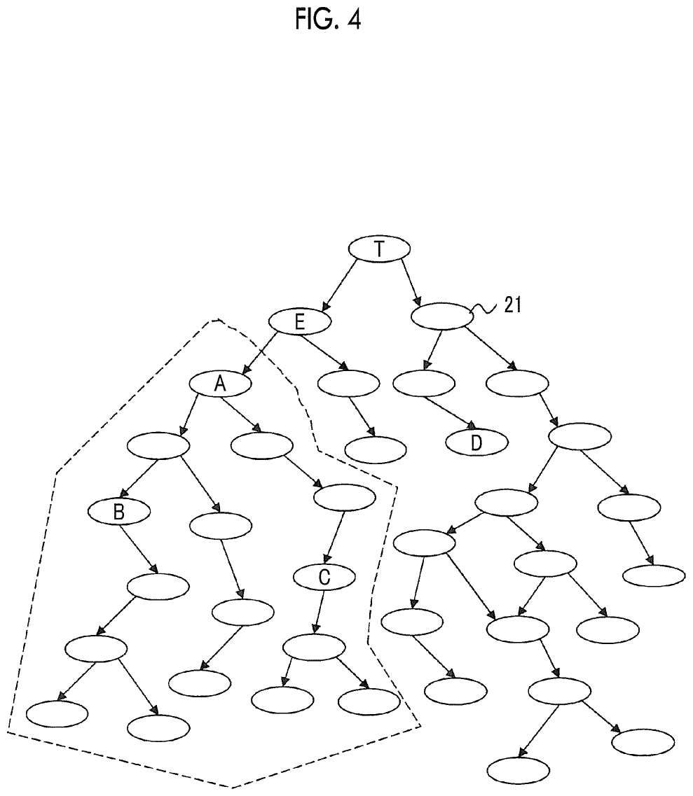

As described above, in the present exemplary embodiment, the difficulty of the search segment is obtained based on the depth to the search segment from the most superordinate concept, and the professionalism degree of the user is decided in accordance with the difficulty. In the present exemplary embodiment, the most superordinate concept is the concept at the most superordinate position among the concepts belonging to the field defined in the concept structure information. The concept as the starting point in the case of obtaining the depth of the search segment may not be the concept at the most superordinate position in the field. Such a case will be described using the schematic diagram of the concept structure information illustrated in FIG. 4.

In FIG. 4, each ellipse 21 denotes a concept. The relationship between concepts, that is, the hierarchically vertical relationship, is illustrated by an arrow. In the field illustrated in FIG. 4, a concept T is the concept at the most superordinate position.

It is assumed that the user designates segments corresponding to a concept B and a concept C present in the concept structure information. In this case, according to FIG. 4, the depths of the concept B and the concept C are 4 and 5, respectively, in a case where the concept T is the most superordinate concept. However, the depths of the concept B and the concept C may be represented as 2 and 3, respectively, in a group that is surrounded by a broken line and has the concept A is the most superordinate concept. Accordingly, the depth of each of the concepts B and C may be obtained by regarding A positioned in the most subordinate layer as the most superordinate concept among concepts T, E, and A that are positioned above both of the concepts B and C designated by the user. Information (depth=2) related to the depth to the concept A from the concept T is additionally necessary from the relationship with other concepts. In the calculation of the difficulty of the concept, the information (depth=2) related to the depth to the concept A from the concept T needs to be used. In a case where the user designates the concept B and a concept D in the query, the most superordinate concept is the concept T (concept at the most superordinate position in the field) in the most superordinate layer among concepts superordinate to both of the concept B and the concept D.

In addition, in the present exemplary embodiment, the depth of the concept is estimated as representing the difficulty of the concept. The professionalism degree of the user is calculated using the depth of the concept. Specifically, the professionalism degree of the user is obtained by dividing the total of the difficulty of each search segment by the number of search segments. The professionalism degree of the user may be calculated as the total of the difficulty of each search segment. That is, in the above description, the average of the difficulty of each search segment is set as the professionalism degree of the user by dividing the total of the difficulty of each search segment by the number of search segments. It is considered that the ability of the user to designate a large number of segments in the query indicates that the user knows a large number of segments related to desired information (that is, the content). By having such a wide range of knowledge, it is considered that the professionalism degree of the user is high. Therefore, the professionalism degree of the user may be calculated without dividing the total of the difficulty of each search segment by the number of search segments.

While the case of using the professionalism degree of the user in the search process is illustratively described in the present exemplary embodiment, the professionalism degree of the user may also be applied to processes other than the search process. The same applies to exemplary embodiments described below.

### Exemplary Embodiment 2

In Exemplary Embodiment 1, a concept at a subordinate position in the hierarchy of concepts indicated by the concept structure information is estimated to be a concept having a high difficulty, and the professionalism degree of the user is decided based on the depth of the concept in the hierarchy. That is, the depth of each search segment is focused as information representing the position of the search segment. In the present exemplary embodiment, the professionalism degree of the user is decided based on a positional relationship between each segment in the hierarchy in addition to the depth of each search segment, that is, the positions (depths) in the hierarchy of concepts corresponding to plural segments designated in the query.

In the present exemplary embodiment, a block configuration and a hardware configuration of an information processing apparatus and the content of a search process may be the same as illustrated in FIG. 1. Only a method of calculating the professionalism degree in the professionalism degree decision unit 12 is different from that of Exemplary Embodiment 1. The professionalism degree of the user is calculated using the following calculation expression.

Professionalism degree=average depth of search segments×average distance between search segments

As illustrated in the calculation expression, the present exemplary embodiment considers the distance between search segments as the positional relationship between each segment in the hierarchy.

For example, it is assumed that the user designates “proportion and inverse proportion” and “simultaneous equations” in the query. According to the concept structure information illustrated in FIG. 2, both of the two concepts (search segments) “proportion and inverse proportion” and “simultaneous equations” belong to the field “expression using variable”, and the depths of the concepts are 1 and 1, respectively. In addition, in the path illustrated by arrows, the distance between “proportion and inverse proportion” and “simultaneous equations” is 2. Accordingly, the professionalism degree maybe calculated as {(1+1)/2}×(2/1)=2.

In addition, it is assumed that the user designates “factorization”, “square root”, and “quadratic equation” in the query. All of “factorization”, “square root”, and “quadratic equation” belong to the field “expression using variable”, and the depths of the concepts are 2, 3, and 3, respectively. While “quadratic equation” is present on two paths, a path including “factorization” is selected in accordance with the above rule since “factorization’ is included in the search segments. The depth of “quadratic equation” is 3. The distance between “factorization” and “square root” is 1. The distance between “square root” and “quadratic equation” is 2. The distance between “quadratic equation” and “factorization” is 1. Thus, the professionalism degree may be calculated as {(2+3+3)/3}×(1+2+1)/3}=3.56.

In addition, it is assumed that the user designates “graph of proportion and inverse proportion” and “quadratic equation” in the query. Both of “graph of proportion and inverse proportion” and “quadratic equation” belong to the field “expression using variable”, and the depths of the concepts are 2 and 2, respectively. Since “quadratic equation” is not present on a path of the other search segment “graph of proportion and inverse proportion”, the minimum value of the depth which is 2 is employed. The distance between “graph of proportion and inverse proportion” and “quadratic equation” is 4. Thus, the professionalism degree may be calculated as {(2+2)/2}×(4/1)=8.

As illustrated thus far, the professionalism degree of the user may be obtained by referring to the depth used in Exemplary Embodiment 1 and also the distance between search segments as the positional relationship between search segments.

The depth of the search segment in the hierarchy is an indicator directly connected to the magnitude of the professionalism degree of the user. However, in a case where search segments have the same depth in the hierarchy but have a long distance therebetween, it is considered that the user has a wide range of knowledge in the field. That is, the professionalism degree of the user having a wide range of knowledge is estimated to be high. Thus, in the calculation of the professionalism degree of the user, the present exemplary embodiment considers the distance between search segments in addition to the depth of the search segment in the hierarchy.

### Exemplary Embodiment 3

In Exemplary Embodiment 1, a concept at a subordinate position in the hierarchy of concepts indicated by the concept structure information is estimated to be a concept having a high difficulty, and the professionalism degree of the user is decided based on the depth of the concept in the hierarchy. The hierarchical relationship between concepts indicated by the concept structure information indicates a relationship between concepts. Depending on the concepts, a case where the depth of the hierarchy is not directly connected to the professionalism level, that is, the difficulty, of the concept may be considered. Therefore, the present exemplary embodiment is conceived in order to handle a case where the depth of the hierarchy is not directly connected to the difficulty.

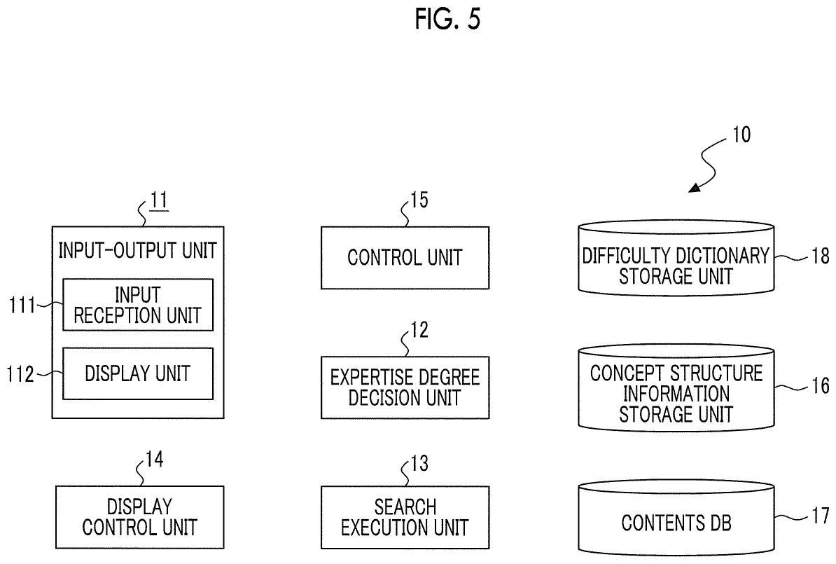

FIG. 5 is a block configuration diagram of an information processing apparatus in the present exemplary embodiment. The same constituents as the configurations illustrated in Exemplary Embodiment 1 will be designated by the same reference signs, and descriptions of such constituents will not be repeated. As illustrated in FIG. 5, the information processing apparatus 10 in the present exemplary embodiment hash a configuration obtained by adding a difficulty dictionary storage unit 18 to Exemplary Embodiment 1.

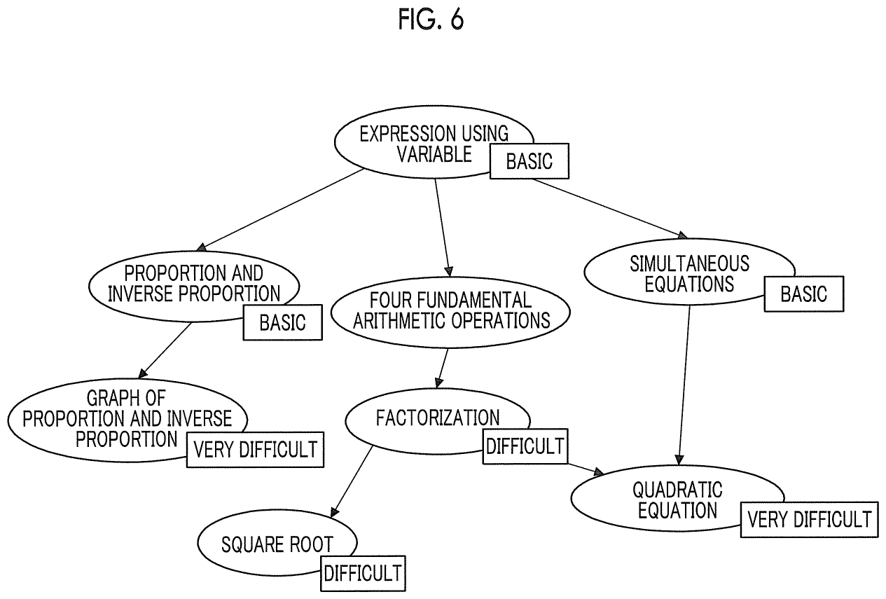

FIG. 6 is a diagram schematically illustrating a difficulty dictionary included in the difficulty dictionary storage unit 18 in the present exemplary embodiment. The difficulty of the segment is set in association with the segment in the difficulty dictionary. The difficulty of the segment set in the difficulty dictionary has the same meaning as the professionalism degree of the segment. In FIG. 6, the difficulty is illustrated by associating the segment set in the difficulty dictionary with the concept indicated in the concept structure information. In the present exemplary embodiment, as illustrated in FIG. 6, difficulties “basic”, “difficult”, and “very difficult” are set for the segments. The difficulties are for illustrative purposes. The number of levels indicating the difficulties and the representations indicating the difficulties are not for limitation purposes. Each difficulty is associated with a numerical value such as “basic”=1″, “difficult”=2″, and “very difficult”=3 such that the professionalism degree is higher as the difficulty is higher. The professionalism degree of the user is calculated using the following calculation expression.

Professionalism degree=Σ(depth of each search segment×difficulty of each search segment)/number of search segments

For example, it is assumed that the user designates “factorization” and “square root” in the query. While both of “factorization” and “square root” belong to the field “expression using variable”, the depth of “factorization” from the most superordinate concept “expression using variable” is 2, and the difficulty of “factorization” is “difficult”=2. In addition, the depth of “square root” from the most superordinate concept “expression using variable” is 3, and the difficulty of “square root” is “difficult”=2. Accordingly, the professionalism degree may be calculated as (2×2+3×2)/2=5. The professionalism degree decision unit 12 may decide the professionalism degree of the user based on the depth of the concept in the hierarchy indicated by the concept structure information and also the difficulty set in the difficulty dictionary.

As in the case of “four fundamental operations” illustrated in FIG. 6, a segment for which the difficulty is not set in the difficulty dictionary may be present. In this case, the professionalism degree decision unit 12 in the present exemplary embodiment sets the difficult of the segment for which the difficulty is not set by referring to the professionalism degrees (difficulties) of other concepts included in the field to which the concept (in the above example, “four fundamental operations”) belongs to.

As a first setting method, the difficulties of concepts having the same depth as the concept in the field are used like “proportion and inverse proportion” and “simultaneous equations” having the same depth as “four fundamental operations” in the concept structure information illustrated in FIG. 6. The difficulties of both of “proportion and inverse proportion” and “simultaneous equations” are “basic”=1. Thus, the difficulty of “four fundamental operations” is set to 1 by calculating the average value of the difficulties. The difficulty is assigned to each segment as a positive integer. However, even in a case where the calculation value of the difficulty is not a positive integer, the calculation result is employed.

Alternatively, the difficulty may be set as follows. First, the maximum depth in the concept structure information is obtained. The maximum depth is 3 in the hierarchical structure illustrated in FIG. 6. Next, the depth of the segment “four fundamental operations” for which the difficulty is set is obtained with respect to the maximum depth. The depth of “four fundamental operations” is 1 in the hierarchical structure illustrated in FIG. 6. Then, a relative depth of “four fundamental operations” which is 1/3 is obtained. Since the highest difficulty is “very difficult”=3, the difficulty of “four fundamental operations” is calculated as 1/3×3=1 by multiplying the relative depth by the highest difficulty.

The above calculation result may be maintained as the difficulty of the concept corresponding to the segment for which the difficulty is not set in the difficulty dictionary. However, the hierarchical relationship indicated by the concept structure information may be updated. Thus, the difficulty of the segment may be obtained by the above calculation as necessary before the difficulty of the segment is set in the difficulty dictionary.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a reception section that receives one or a plurality of segments input by a user;
a first specifying section that specifies each concept corresponding to at least one segment received by the reception section among concepts present in concept structure information in which concepts having a relationship are related to each other in a hierarchical structure;
a second specifying section that specifies a position of each concept specified by the first specifying section in a hierarchy of the concept structure information; and
a decision section that decides a professionalism degree of the user in a field which is specified based on the concept structure information including the concept corresponding to the segment received by the reception section from the position of each concept specified by the second specifying section.

2. The information processing apparatus according to claim 1,
wherein the decision section decides that the professionalism degree of the user is higher as the position in the hierarchy of the concept corresponding to each segment received by the reception section is deeper.

3. The information processing apparatus according to claim 2,
wherein as the number of concepts present between a most superordinate concept of the concept structure information and the concept at the position specified by the second specifying section is larger, the concept at the position specified by the second specifying section is deeper.

4. The information processing apparatus according to claim 2,
wherein in a case where the concept corresponding to the segment is related to a plurality of concepts, a path including the concept specified by the first specifying section is specified between a most superordinate concept of the concept structure information and the concept corresponding to the segment which is related to the plurality of concepts, and the depth of the position in the hierarchy of the concept corresponding to each segment received by the reception section is decided from the number of concepts present between the most superordinate concept of the concept structure information and the concept at the position specified by the second specifying section in the specified path.

5. The information processing apparatus according to claim 3,
wherein in a case where the concept corresponding to the segment is related to a plurality of concepts, a path including the concept specified by the first specifying section is specified between a most superordinate concept of the concept structure information and the concept corresponding to the segment which is related to the plurality of concepts, and the depth of the position in the hierarchy of the concept corresponding to each segment received by the reception section is decided from the number of concepts present between the most superordinate concept of the concept structure information and the concept at the position specified by the second specifying section in the specified path.

6. The information processing apparatus according to claim 1,
wherein a professionalism degree of the concept is set in the concept present in the concept structure information, and
the decision section decides the professionalism degree of the user based on the professionalism degree of the concept corresponding to the position of each segment specified by the second specifying section.

7. The information processing apparatus according to claim 6, further comprising:
a setting section that sets a professionalism degree of the concept for which the professionalism degree is not set among the concepts present in the concept structure information by referring to the professionalism degree of another concept included in a field to which the concept belongs,
wherein in a case where the professionalism degree is not set in the concept corresponding to the segment received by the reception section, the decision section decides the professionalism degree of the user by referring to the professionalism degree of the concept set by the setting section.

8. The information processing apparatus according to claim 1,
wherein the decision section decides the professionalism degree of the user based on a positional relationship in the hierarchy of the concept corresponding to each segment received by the reception section.

9. The information processing apparatus according to claim 8,
wherein the decision section decides that the professionalism degree of the user is higher as a distance of the concept corresponding to each segment received by the reception section from a most superordinate concept of the concept structure information is longer.

10. A non-transitory computer readable medium storing a program causing a computer to function as:
a reception section that receives one or a plurality of segments input by a user;
a first specifying section that specifies each concept corresponding to at least one segment received by the reception section among concepts present in concept structure information in which concepts having a relationship are related to each other in a hierarchical structure;
a second specifying section that specifies a position of each concept specified by the first specifying section in a hierarchy of the concept structure information; and
a decision section that decides a professionalism degree of the user in a field which is specified based on the concept structure information including the concept corresponding to the segment received by the reception section from the position of each concept specified by the second specifying section.

11. An information processing apparatus comprising:
reception means for receiving one or a plurality of segments input by a user;
first specifying means for specifying each concept corresponding to at least one segment received by the reception section among concepts present in concept structure information in which concepts having a relationship are related to each other in a hierarchical structure;
second specifying means for specifying a position of each concept specified by the first specifying means in a hierarchy of the concept structure information; and
decision means for deciding a professionalism degree of the user in a field which is specified based on the concept structure information including the concept corresponding to the segment received by the reception means from the position of each concept specified by the second specifying means.
